(19) United States
(12) Patent Application Publication
(10) Pub. No.: US 2011/0166928 A1
(43) Pub. Date: Jul. 7, 2011

(54) Method of Sharing Possessions among Friends Connected through a Social Network

(75) Inventors: Chloe Robinson, La Jolla, CA (US); Dana B. Robinson, La Jolla, CA (US)

(73) Assignee: SHARITABLE, LLC, Las Vegas, NV (US)

(21) Appl. No.: 12/683,150

(22) Filed: Jan. 6, 2010

(51) Int. Cl. G06Q 99/00; G06Q 30/00; G06F 3/01; G06F 17/30

(52) U.S. Cl. 705/14.49; 705/319; 715/753; 707/769; 707/E17.014

(57) ABSTRACT

A method of sharing possessions among friends connected through a social network whereby friends post sharable items viewable and searchable by keywords, description, and data by their friends and provides means for notification of friends' desire to borrow said items. Upon item sharing, friends can acknowledge receipt and condition of items borrowed, notify borrower's failure to return borrowed items, purchase damage waiver insurance, and rate the quality of the borrower. A method to encourage friends to donate to charities by offering to gift distinct or sharable items, whereby donations must be received by borrower's or lender's selected charities before gifting, and donations can be coordinated by third parties. Users can post requests for items desired as gifts or monetary amounts they're willing to donate upon gift receipt. Items available for gift are searchable and advertisements are displayed to users based on user's searched keywords.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The invention described herein relates to a method of sharing possessions among friends connected to each other through a social network and encouraging said friends to donate to charities upon the sharing of said possessions.

Borrowing a friend's possessions and lending one's personal items have long been favorite means of people to obtain and distribute needed items as an alternative to purchasing the said item. Whether due to geographical proximity, personal relationships, or common social pursuits or intellectual interests; friends, family and associates often share resources to aid or support others at a reduced (or without) cost compared to purchasing the said resources. A lender often implicitly recommends an item to a borrower when the lender makes an item available to be borrowed based on his/her experience with the item in the past. This process has long been indicative of the lender's confidence in the borrower to return the item in the same state it was originally lent with minor and insignificant damage or signs of use. There are few if any tools that allow people to effectively share things with friends, and it is difficult for someone to figure out what his friends may have available to loan. One can email all of his friends; or call people until he finds a camping tent to borrow, or a shop vacuum. But, until the Sharitable application claimed here was developed, there was no simple method to efficiently allow friends to list items to loan and search the borrowable items of their friends.

During the Internet's relatively short history, search engines such as Google and Yahoo! have been its main driving force. The recent swift development and expansion of social networking sites, most notably Facebook and MySpace, has exposed a novel trend of Internet usage. These social networking sites by and large mediate user's ability to establish, sustain, and develop their friend network and promote services and applications that aid this process. Due to the extreme popularity and traffic of Internet users to these social networking sites, they have become a user-friendly hub for the sharing of data and information including picture, music, multimedia and other analogous files. The existence of a prior social network allows for those within the network to operate within a level of trust between friends in a network.

Another main use of the internet is the purchasing and renting of goods through ecommerce companies such as Amazon and eBay. These companies have tried to create a balanced environment on the internet involving both social aspects and enhanced seller/buyer interactions. Furthermore, these sites provide means for users to rate and recommend both items and other buyers and sellers. These ratings are usually on a quantifiable scale, evaluating various aspects such as quality, speed, and cost based on a user's experience with said item or buyer/seller. This has resulted in increased consumer confidence in purchases, sales, and information sharing. However, because most commercial websites are focused on offering things for sale to the largest possible network, the use of a narrow network such as an existing social network to offer goods has not been done before. The Sharitable application's method allows users to offer things to “share” with a group of people that they likely know personally, and have an inherent trust in existence prior to the “borrowing/lending” relationship. The social network offers a unique forum to enable pre-existing friends or acquaintances to share and borrow things from each other that would not be appropriate to the entire world of Internet users.

To date, none of the existing systems, websites, or applications has sought or successfully created a method of sharing possessions among social network friends. The systems currently established focus strictly on the selling and purchasing of goods instead of sharing, lending, and borrowing goods. As a result, to obtain needed goods, internet users must spend capital to buy the goods and establish ownership rights. However, many items purchased by consumers are only needed for a limited or one time use and results in consumer purchasing aversion and even deters many purchases as the consumer feels it is not worth the money to own an item that will not be used consistently. This method also leads to waste as many consumers will remove the purchased items from their possession after using the item for its intended purpose. Furthermore, these systems fail to manage and organize a network displayed inventory of available items, too often resulting in delays in consumer's receipt of the goods for which have been paid.

Charitable donating is a well-known, long-standing, and worldwide practice and numerous organizations operate for non-profit and/or charitable functions. Many charities go to great lengths to increase donations and exposure to prospective donors. Many charities hold telethons, walkathons, silent auctions, and/or setup endowments and campaigns for specific initiatives such as scholarships, to increase donations. The promotion and holding of these events and initiatives often come with significant costs to the charity in the form of man-power and advertising capital. Furthermore, many of these events and initiatives fail to target a maximized potential donor pool and represents and untapped opportunity for fundraising organizations. Additionally, many times a potential donor must be in possession of the charity's address or specialized donation form to be able to transmit the donation correctly, and bears the burden of postage and telephone call costs, making the donation process problematic and/or difficult, especially to distant donors. Accordingly, there exists a need for methods for charities to minimize the said costs associated with reaching out to donors, while targeting a larger potential donor pool and permitting a donor to readily donate without the need to possess a specific donation form, know the address of the charity, and/or expend funds. Although the use of the Internet by charities has enlarged the amount and type of charitable donations and has made the donation process easier for donors, many of the aforementioned problems still remain.

### BRIEF SUMMARY OF THE INVENTION

Accordingly, there is a need for a method of sharing possessions among friends on a social network as an alternative to purchasing goods through the internet. The method claimed here provides a means of easily borrowing and lending physical possessions among friends on a social network through the ability of friends to post items to share and allowing friends to view the items shared by their friends and promotes reciprocal sharing. Moreover, the claimed method allows friends in a social network to rate and regulate each other's borrow-worthiness. One can rank a friend who returned an item in perfect shape and on time high, while ranking low the friend who broke an item and didn't replace it. A calendar system and keyword search make the method an effective tool to manage each person's personal inventory of items to loan, as well as managing the things that one has borrowed to ensure that one does not forget the things that he has borrowed. Also, borrowers are offered the choice of protection for damage that may incur during the time they borrow and use the lent item. Borrowers can choose to purchase damage waiver insurance protection that is charged to the borrower upon the lender approving the borrower's choice of items that the borrower intends to borrow.

A further object of this invention is to help solve many of the problems with charitable donation mentioned above. Firstly, because lenders and borrowers are able to choose and display the charities they prefer to receive donations, which have previously agreed to the terms of the donation program before said donations are able to be consummated, these selected charities are promoted to the user's friends in their social network without any further significant cost to the charity. Thus, the potential donor pool for the selected charity is increased at minimal cost to the charity leaving a smaller percentage of the donated funds to be utilized for promotion of and labor for the charity. Furthermore, through this method, charities may not need to expend as much capital as previously used to promote donations through events such as walkathons, telethons, and silent auctions, due to the increased promotion of donations to the said charity from users of the Sharitable application. Additionally, users of the Sharitable application that donate using the application as well, do so without expending any additional costs associated with donating to a charity of unknown location or for which a user does not have a specific form for the said charity. Donations are made electronically through the Sharitable application. Thus, funds from the user are directly deposited into a predetermined account associated with the chosen charity, without the need for user possession of donation forms, telephone calls, or knowledge of the charities location. Moreover, donators will receive charitable donation credit for tax purposes when they donate to a charity through a website using the Sharitable application. This process further increases the user-friendliness of the donation method. Although dispensing donation credits/receipts may come at a small cost to the charity, the claimed invention allows for third-parties to coordinate donations to charities and gifts between friends for a fee, thus eliminating the cost of donation receipt distribution to the charity. Finally, due to the ability of users to offer any item for lend for gift to a friend in exchange for that friend donating to a charity, the number and amount of donations made to the said charity should increase by the number of people willing to donate in order to borrow from the lender, again at no cost to the charity.

### BRIEF DESCRIPTION OF THE DRAWINGS

Not Applicable

### DETAILED DESCRIPTION OF THE DRAWINGS

Not Applicable

### DETAILED DESCRIPTION OF THE INVENTION

The preferred embodiment of the present invention is directed toward a method of sharing items among friends that are connected to each other through a social network such as, but not limited to, Facebook or MySpace. As used herein, friends include any persons connected to one another as a result of the friend approval process specific for each social networking site. Depending on the particular status of the social network users, friends may be more specifically referred to as lenders (the friend who has a particular item posted for sharing with another friend), borrowers (the friend who desires to borrow a particular item that has been posted by a lender for sharing with another friend), gifters (the friend who has a particular item posted for gifting to another friend who agrees to donate something of value to a charity in return for receiving the item as a gift), and the recipient (the friend who agrees to donate something of value to a charity in return for receiving a particular item posted for gifting by a friend).

Participation in the preferred embodiment of the present invention is restricted to friends connected trough a social network site. Items owned by one lender may be borrowed by another borrower so long as the said lender and borrower are already friends and if the lender approves. The said borrower may also lend his/her owned items to said lender, leading to reciprocity and increased trust levels between said friends.

Furthermore, borrowing from, loaning to, gifting to, and receiving from, particular friends may be restricted based on the level of trust associated between said friends. The trust level amongst friends can be established based on a rating system with predetermined criteria and personal knowledge of the said friend. When the trustworthiness of the potential borrower is equal to or above that required by the lender, the lender may approve the borrowing of items by the borrower.

Lenders may lend any items they currently own or control, and the number of items available for lending are limitless. These can include for example, books, videos, sporting equipment, large machinery, vehicles, residences and almost any other item within the realm of reason. The borrower understands that the items are still retained, owned, and controlled by the lender. The borrower returns the items and is rated by the lender, increasing or decreasing his or her worthiness with future lenders.

A lender of an item can post items to give away as well, or convert an item for loan to an item for give away. The lender who becomes a gifter can designate a preferred charity to whom a recipient of the item can make a donation to.

In the preferred embodiment, an item to be loaned can be exchanged by any method deemed acceptable and agreed upon by both the lender and borrower. For example, the items could be picked up by the borrower at a physical location determined by the lender, or the item could be shipped by any means to the borrower such as USPS, FedEx, and UPS, at either the borrower's or lender's expense.

I claim:

1. A method of sharing possessions between friends that are connected on a social network that allows friends to post items to share and allows friends to view the items shared by their friends;

2. A method of claim 1 where friends can request to borrow items from a friend by using a private messaging system to notify the friend of the desire to borrow and friends with items to lend can approve or disapprove the request.

3. A method of claim 1 where friends that lend can rate the quality of the borrower for others to view the borrower's borrow-worthiness.

4. A method of claim 1 where friends can identify the availability of items that are available to lend such that friends can determine and search availability of items they wish to borrow through a searchable database of items by keywords, description, and data

5. A method of claim 1 whereby borrowers may purchase a damage waiver insurance protection that is charged to the borrower upon the lender approving the borrower's choice of items that the borrower intends to borrow.

6. A method of claim 1 that employs a searchable database of items, keywords, and/or borrower's ratings.

7. A method of claim 1 that allows the lender to acknowledge receipt and condition of items borrowed upon return by the borrower.

8. A method of claim 1 that allows the lender to notify the borrower of failure to return an item borrowed, and/or acknowledgement of the return of an item with or without a condition of the item being identified.

9. A method of encouraging friends in a social network to donate to a charity by offering to gift an item to a friend if that friend donates money or something of value to a charity;

10. A method of claim 9 whereby the friend offering to gift an item selects a charity of choice that must receive a donation before the item is gifted to the friend who donates something of value to the charity.

11. A method of claim 9 whereby a user can add a charity of choice to the list of selectable charities, resulting in a communication being sent to the charity requesting that said charity agree to the terms of a donation program before a donation contemplated in claim 5 can be consummated with said charity.

12. A method of claim 9 whereby a user can receive charitable donation credit for donating to a charity through a website.

13. A method of claim 9 whereby the items available for gift to friends are searchable by various data entered by the user.

14. A method of claim 9 whereby users can post requests for particular items that they desire to receive as gifts from friends.

15. A method of claim 14 whereby users can post an amount that they are willing to donate to a charity if they receive a gift.

16. A method of claim 9 whereby a third-party can coordinate gifts between friends and donations to charities.

17. A method of claim 16 whereby a third-party can receive a fee or other consideration from charities for receiving donations on behalf of said charity.

18. A method of claim 1 whereby advertisements are displayed to users based on keywords arising in the user's search of the database and items offered to lend that they are viewing.

19. A method of claim 1 whereby users can offer any item for lend or gift to a friend in exchange for that friend donating to a charity.

20. A method of claim 19 where the charity is selected by either the friend that offers the item or by the friend that donates to the charity or a charity is selected by the friend that donates money to a charity.
